(19) United States
(12) Patent Application Publication
(10) Pub. No.: US 2024/0007003 A1
(43) Pub. Date: Jan. 4, 2024

(54) POWER SUPPLY CIRCUITS AND ELECTRONIC DEVICES

(71) Applicant: SHENZHEN HONOR ELECTRONIC CO.,LTD, Shenzhen (CN)

(72) Inventors: Liang HU, Shenzhen (CN); Liyan LIN, Shenzhen (CN); Yuetian WANG, Shenzhen (CN)

(21) Appl. No.: 18/344,929

(22) Filed: Jun. 30, 2023

(30) Foreign Application Priority Data
Jun. 30, 2022 (CN) 202210772929.0

(51) Int. Cl. H02M 3/335; H02M 1/00; H02M 1/12

(52) U.S. Cl. CPC H02M 3/33523; H02M 1/0006; H02M 1/0009; H02M 1/126

(57) ABSTRACT

A power supply circuit includes: a power input terminal configured to provide first power; at least two power output terminals each configured to provide second power to an external load; at least two flyback conversion circuits each coupled to the power input terminal and a respective one of the at least two power output terminals to convert the first power to the second power; and a flyback control circuit coupled to each of the at least two flyback conversion circuits, the flyback control circuit being configured to control the at least two flyback conversion circuits to be connected in parallel when one of the at least two power output terminals outputs the second power.

### CROSS-REFERENCE TO RELATED APPLICATION

This application claims priority to and the benefit of Chinese Patent Application No. 202210772929.0, filed on Jun. 30, 2022, the disclosure of which is incorporated herein by reference in its entirety.

### TECHNICAL FIELD

The present disclosure relates to electronic technologies, and more particularly, to power supply circuits and electronic devices.

### BACKGROUND

Adapters, also known as power adapters, are used to charge devices to be charged. With the development of the power adapters, power adapters equipped with dual TYPE-C (a type of a universal serial bus (USB) interface) output ports have emerged on the market.

A power adapter with the dual TYPE-C output ports generally adopts two Direct Current/Direct Current (DC/DC) conversion circuits to reduce a voltage of an input power supply, respectively, thereby enabling charging via the dual TYPE-C output ports.

With the power adapter, if main power fails to rise to a sufficiently suitable voltage, a post-stage circuit of the power adapter may bear an excessive current, which results in a potential safety hazard.

### SUMMARY

According to a first aspect, an embodiment of the present disclosure provides a power supply circuit including: a power input terminal configured to provide first power; at least two power output terminals each configured to provide second power to an external load; at least two flyback conversion circuits each coupled to the power input terminal and a respective one of the at least two power output terminals to convert the first power to the second power; and a flyback control circuit coupled to each of the at least two flyback conversion circuits, the flyback control circuit being configured to control the at least two flyback conversion circuits to be connected in parallel when one of the at least two power output terminals outputs the second power.

According to a second aspect, an embodiment of the present disclosure provides an electronic device including a power supply circuit according to the first aspect.

### BRIEF DESCRIPTION OF THE DRAWINGS

FIG. 1 is a schematic structural diagram of a power supply circuit according to one or more embodiments of the present disclosure.

FIG. 2 is a schematic structural diagram of a power supply circuit according to one or more embodiments of the present disclosure.

FIG. 3 is a schematic structural diagram of a flyback conversion circuit according to one or more embodiments of the present disclosure.

FIG. 4 is a schematic structural diagram of a flyback conversion circuit according to one or more embodiments of the present disclosure.

FIG. 5 is a schematic structural diagram of a power supply circuit according to one or more embodiments of the present disclosure.

FIG. 6 is a schematic structural diagram of a second controller unit according to one or more embodiments of the present disclosure.

FIG. 7 is a schematic structural diagram of a power supply circuit according to one or more embodiments of the present disclosure.

FIG. 8 is a schematic structural diagram of a power supply circuit according to one or more embodiments of the present disclosure.

### DETAILED DESCRIPTION

Some embodiments of the present disclosure will be described in detail below with reference to the drawings. The embodiments are provided for illustrative purposes only, not intended to limit the scope of the present disclosure.

In the description of the present disclosure, the terms “first” and “second” are used for descriptive purposes only, and cannot be interpreted as indicating or implying relative importance or implicitly specifying quantity of indicated technical features. Thus, a feature defined as “first” or “second” may explicitly or implicitly include one or more of such features. In the description of the present disclosure, “a plurality of” means two or more, unless otherwise specifically defined.

In the present disclosure, the word “exemplary” is used to mean “serving as an example, illustration, or explanation”. Any embodiment described as “exemplary” in the present disclosure is not necessarily to be construed as preferred or advantageous over other embodiments. The following description is given to enable any person skilled in the art to realize and use the present disclosure. In the following description, details are set forth for purposes of explanation. It should be understood that a person having ordinary skills in the art would recognize that the present disclosure may be practiced without these specific details. In other instances, well-known structures and processes are not described in detail to avoid unnecessary detail from obscuring the description of the present disclosure. Thus, the present disclosure is not intended to be limited to the embodiments shown, but is consistent with the widest scope in compliance with the principles and features disclosed in the present disclosure.

Currently, an adapter with dual TYPE-C output ports in the market adopts two Direct Current/Direct Current (DC/DC) conversion circuits to reduce a voltage of an input power supply, respectively, and the reduced voltage is output to the TYPE-C output ports corresponding to the two DC/DC conversion circuits, respectively, thereby enabling both of the dual TYPE-C output ports to charge. The adapter with the two DC/DC conversion circuits are large in size, high in a manufacturing cost, and high in circuit loss during operation.

To solve this problem, some solutions adopt one DC/DC conversion circuit and set the two TYPE-C output ports to include one high-power TYPE-C output port and one low-power TYPE-C output port. When both of the two TYPE-C output ports are connected to external loads, the high-power TYPE-C output port in work has to reduce an original high-power output to a low-power output, and then provide an output to the low-power TYPE-C output port through the DC/DC conversion circuit.

Although this solution solves the problems in the adapter with the two DC/DC conversion circuits, in a design process, this solution has to ensure that the high-power TYPE-C output port is capable of outputting a sufficiently large power, and meanwhile being compatible with a low-power output when both of the two TYPE-C output ports are connected to the external loads, and avoiding an excessively low power which cannot meet charging requirements of the external loads. In addition, in a process of high-power output at the low power TYPE-C output port, if the main power does not rise to a sufficient voltage, a synchronous rectifying circuit and secondary winding of a transformer unit in the adapter withstands an excessive current, which results in a certain potential safety hazard. This may easily bring a poor experience to a user. Therefore, the solution in which the adapter adopts two TYPE-C output ports including one high-power TYPE-C output port and one low-power TYPE-C output port and one DC/DC conversion circuit still has many problems to be solved.

To solve the above technical problems, embodiments of the present disclosure provide a power supply circuit and an electronic device, which are described in detail below.

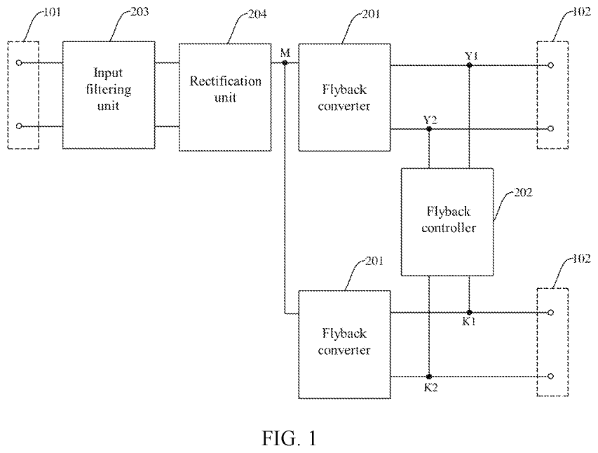

FIG. 1 is a schematic structural diagram of a power supply circuit according to one or more embodiments of the present disclosure. The power supply circuit includes a power input terminal 101, at least two power output terminals 102, at least two flyback conversion circuits 201, and a flyback control circuit 202.

The power input terminal 101 is configured to provide first power. The power input terminal 101 may be directly connected to mains electricity or connected to an energy storage device, and is configured to supply power to the power supply circuit. In the present embodiment, the power input terminal 101 is connected to an external power source. The external power source may be an Alternating Current (AC) power source, an AC/Direct Current (DC) power source, a DC/DC power source, a regulated power source, a communication power source, a variable frequency power source, an inverter power source, an AC regulated power source, or the like, which are not specifically limited in the present embodiment.

The at least two power output terminals 102 are configured to provide second power to an external load. In the present embodiment, the power output terminals 102 may be an USB Type-C interface, an USB Type-C male connector, or any other interface or connector that can perform power transmission, which are not specifically limited in the present embodiment.

The at least two flyback conversion circuits 201 are each coupled to the power input terminal 101 and respectively coupled to the at least two flyback conversion circuits 201. The at least two flyback conversion circuits are configured to convert the first power to the second power.

The flyback control circuit 202 is coupled to each of the at least two flyback conversion circuits 201, and is configured to control the at least two flyback conversion circuits 201 to be connected in parallel when one of the at least two power output terminals 102 outputs the second power.

In the present embodiment, the flyback control circuit 202 also controls the at least two flyback conversion circuits 201 to be disconnected when each of the at least two power output terminals 102 outputs the second power.

In the present disclosure, when one of the at least two power output terminals 102 outputs the second power, the flyback control circuit 202 controls the at least two flyback conversion circuits 201 to be connected in parallel. At this time, the at least two flyback conversion circuits 201 perform flyback conversion on the first power simultaneously and supply the second power to the power output terminal 102 connected to the external load, so that when the second power is output through one of the at least two power output terminals 102, the at least two flyback conversion circuits 201 perform current sharing on the first power and power withstood by the at least two flyback conversion circuits 201 are balanced. When each of the at least two power output terminals 102 outputs the second power, the flyback control circuit 202 controls the at least two flyback conversion circuits 201 to be disconnected. At this time, the at least two flyback conversion circuits 201 work independently of each other, so that the at least two power output terminals 102 supply power to the outside. Therefore, the power supply circuit of the present disclosure supports outputting the second power through each of the at least two power output terminals, and achieves current sharing when the second power is output through one power output terminal, which avoids an output side of the power supply circuit from bearing an excessive current, improves safety of a use process, and can ensure that the at least two output terminals are independent from each other when the second power is output through each of the at least two output terminals.

In the present embodiment, the power supply circuit further includes an input filtering unit 203 coupled to the power input terminal 101 and configured to filter the first power.

In the present embodiment, the input filtering unit 203 may be a specific input filtering circuit.

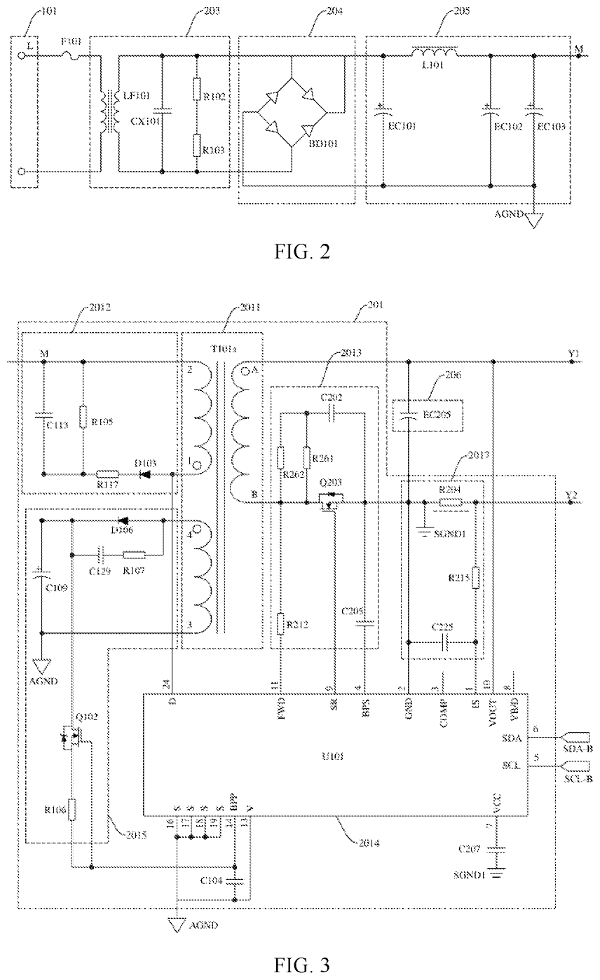

In the present embodiment, as shown in FIG. 2, the input filtering unit 203 includes a common-mode inductor LF101 and a first capacitor CX101. The first capacitor CX101 is an X capacitor. The common-mode inductor LF101 includes a first coil and a second coil. One terminal of the first coil and one terminal of the second coil are coupled to a neutral line and a live line of the power input terminal 101, respectively, and the other terminal of the first coil and the other terminal of the second coil are coupled to two terminals of the first capacitor CX101, respectively.

A combined effect of the common-mode inductor LF101 and the first capacitor CX101 suppresses common-mode interference in an AC power supply signal input from the power input terminal 101. Because different X capacitors have different high voltage resistance values, capacitance of the first capacitor CX101 can be adjusted to change a cutoff frequency of the first capacitor CX101 according to a specific actual situation. Component parameters of the common-mode inductor LF101 and the first capacitor CX101 are not specifically limited in the present disclosure.

In the present embodiment, other input filtering units 203 capable of filtering the first power may be used, and a structure adopted by the input filtering unit 203 is not specifically limited in the present disclosure.

In the present embodiment, the input filtering unit 203 further includes a first resistor R102 and a second resistor R102, which are coupled in series and are coupled to two terminals of the first capacitor CX101. The first resistor R102 and the second resistor R102 serve as charge-discharge resistors of the first capacitor CX101 to perform a charge-discharge function of the first capacitor CX101, thereby supplying power to a subsequent stage circuit of the power supply circuit.

In some embodiments, the input filtering unit 203 further includes a fuse wire F101 coupled between the input filtering unit 203 and the live wire of the power input terminal 101. When a circuit current rises abnormally to a certain height and certain heat, the fuse wire F101 fuses and cuts off the circuit current to protect the circuit.

In some embodiments, the power supply circuit further includes a rectifying unit 204 coupled to the input filtering unit 203 and configured to rectify the first power.

In some embodiments, the rectifying unit 204 may be a specific rectifying circuit.

Specifically, the rectifying unit 204 includes a rectifier bridge BD101 connected by four independent rectifier diodes. Two input terminals of the rectifier bridge BD101 are coupled to two terminals of the first capacitor CX101, and two output terminals of the rectifier bridge BD101 are coupled to a 7C filtering unit 205 (see below). The filtered first power is rectified by the rectifier bridge BD101 to obtain a rectified first power.

In the present embodiment, other rectifying units 204 capable of rectifying the first power may be used, and a structure of the rectifying unit 204 is not specifically limited in the present disclosure.

In some embodiments, the power supply circuit further includes the 7C filtering unit 205 coupled to the rectifying unit 204 and configured to filter the rectified first power.

In some embodiments, the 7C filtering unit 205 may be a specific 7C filtering circuit.

In some embodiments, the 7C filtering unit 205 includes a first electrolytic capacitor EC101, a second electrolytic capacitor EC102, a third electrolytic capacitor EC103, and a first inductor L101. An anode and a cathode of the first electrolytic capacitor EC101 are respectively coupled to two output terminals of the rectifier bridge BD101. Two terminals of the first inductor L101 are respectively coupled to the anode of the first electrolytic capacitor EC101 and an anode of the second electrolytic capacitor EC102. A cathode of the second electrolytic capacitor EC102 is coupled to the cathode of the first electrolytic capacitor EC101. An anode and a cathode of the third electrolytic capacitor EC103 are respectively coupled to the anode and the cathode of the second electrolytic capacitor EC102. The cathode of the first electrolytic capacitor EC101, the cathode of the second electrolytic capacitor EC102, and the cathode of the third electrolytic capacitor EC103 are commonly coupled to ground.

In the present embodiment, a combined effect of the first electrolytic capacitor EC101, the second electrolytic capacitor EC102, the third electrolytic capacitor EC103, and the first inductor L101 further filter the rectified first power, so as to reduce a ripple current in the first power and make the first power more stable. Meanwhile, the first electrolytic capacitor EC101, the second electrolytic capacitor EC102, and the third electrolytic capacitor EC103 further have an energy storage function, so that the rectified first power can be stored. The first electrolytic capacitor EC101, the second electrolytic capacitor EC102, and the third electrolytic capacitor EC103 can be continuously charged and discharged, thereby transmitting the first power to the subsequent stage circuit of the power supply circuit in a form of a charging and discharging current.

In the present disclosure, the at least two flyback conversion circuits 201 are used to perform voltage conversion on the first power. The at least two flyback conversion circuits 201 may adopt a same circuit structure or may adopt different circuit structures on the premise that the at least two flyback conversion circuits 201 have a same function. Therefore, in the present disclosure, one of the structures adopted by the flyback conversion circuits 201 and a function thereof are described as an example.

In one embodiment of the present disclosure, the flyback conversion circuit 201 includes a transformer unit 2011 coupled between the power input terminal 101 and a respective one of the power output terminals 102 and configured to perform voltage conversion on the first power.

In the present embodiment, as shown in FIG. 3, the transformer unit 2011 specifically includes a transformer T101a including a primary coil, a first secondary coil, and a second secondary coil. The primary coil of the transformer T101a is coupled to the 7C filtering unit 205. The first secondary coil of the transformer T101a is coupled to a synchronous rectification and filtering circuit 2013 (see below), and the second secondary coil of the transformer T101a is coupled to a power conversion circuit 2015 (see below). The transformer T101a performs a voltage conversion on the rectified and filtered first power, and the first power converted to a set voltage value is supplied to the synchronous rectification and filtering circuit 2013 and the power conversion circuit 2015, respectively.

In the present embodiment, the transformer unit 2011 may adopt other circuit structures which may function as the voltage conversion, which are not specifically limited in the present disclosure.

In the present embodiment, the flyback conversion circuit 201 further includes a voltage absorption unit 2012 coupled between the power input terminal 101 and the transformer unit 2011 and configured to absorb a peak voltage generated by the primary coil of the transformer T101a.

In the present embodiment, as shown in FIG. 3, the voltage absorbing unit 2012 specifically includes a second capacitor C113, a third resistor R105, a fourth resistor R117, and a first diode D103. One terminal of the second capacitor C113 is coupled to the anode of the third electrolytic capacitor EC103, and the other terminal of the second capacitor C113 is coupled to a cathode of the first diode D103 through the fourth resistor R117. Two terminals of the third resistor R105 are coupled to two terminals of the second capacitor C113. A first terminal 2 of the primary coil of the transformer T101a is coupled to one terminal of the third resistor R105, and a second terminal 1 of the primary coil of the transformer T101a is coupled to an anode of the first diode D103.

In the present embodiment, the second capacitor C113, the third resistor R105, the fourth resistor R117, and the first diode D103 together constitute an RCD absorption circuit, through which the peak voltage generated by the primary coil of the transformer T101a is absorbed when the primary coil of the transformer T101a is turned on or off.

In some embodiments, the voltage absorption unit 2012 may also adopt other circuit structures that may absorb a spike voltage generated by the primary coil of the transformer T101a, which are not specifically limited in the present disclosure.

In some embodiments, the flyback conversion circuit 201 further includes: the synchronous rectification and filtering circuit 2013.

The synchronous rectification and filtering circuit 2013 is coupled between the transformer unit 2011 and the power output terminals 102 and is configured to perform rectification and filtering on the first power after the voltage conversion.

In some embodiments, as shown in FIG. 3, the synchronous rectification and filtering circuit 2013 specifically includes a third switching transistor Q203, a third capacitor C202, a twentieth resistor R261, and a twenty-first resistor R262. The third switching transistor Q203 may adopt an N-channel Metal-Oxide-Semiconductor Field Effect Transistor (i.e., an NMOS transistor) or a P-channel Metal-Oxide-Semiconductor transistor (i.e., a PMOS transistor), which are not specifically limited in the present embodiment.

In some embodiments, a third body diode is coupled to the third switching transistor Q203, wherein an anode of the third body diode is coupled to a source of the third switching transistor Q203, and a cathode of the third body diode is coupled to a drain of the third switching transistor Q203. A gate of the third switching transistor Q203 is coupled to a first controller unit 2014 (see below), the drain of the third switching transistor Q203 is coupled to a first terminal B of the first secondary coil of the transformer T101a, both of the source of the third switching transistor Q203 and a second terminal A of the first secondary coil of the transformer T101a are coupled to the power input terminal 101, one terminal of the third capacitor C202 is coupled to the drain of the third switching transistor Q203 through the twentieth resistor R261, the other terminal of the third capacitor C202 is coupled to the source of the third switching transistor Q203, and the twenty-first resistor R262 is connected in parallel to two terminals of the twentieth resistor R261.

In the present embodiment, by turning on and off the third switching transistor Q203, the first power after the voltage conversion is subjected to the rectification and filtering. The third capacitor C202, the twentieth resistor R261, and the twenty-first resistor R262 together constitute an RC absorption circuit for absorbing a peak voltage generated during a turn-off process of the third switching transistor Q203.

In the present embodiment, the synchronous rectification and filtering circuit 2013 further includes a twenty-second resistor R212, one terminal of which is coupled to a drain of the third switching transistor Q203, and the other terminal of which is coupled to the first controller unit 2014. A voltage of the first secondary coil of the transformer T101a is detected by the twenty-second resistor R212 to provide a reference for the first controller unit 2014 to control a synchronous rectification of the third switching transistor Q203.

In the present embodiment, the synchronous rectification and filtering circuit 2013 further includes a ninth capacitor C205, one terminal of which is coupled to a source of the third switching transistor Q203, and the other terminal of which is coupled to the first controller unit 2014. The ninth capacitor C205 serves as a decoupling capacitor and configured to filter out interference in a control signal output by the first controller unit 2014.

In the present embodiment, the synchronous rectification and filtering circuit 2013 may have other circuit structures that may perform rectification and filtering on the first power after the voltage conversion, which are not specifically limited in the present disclosure.

In the present embodiment, the flyback conversion circuit 201 further includes the first controller unit 2014.

The first controller unit 2014 is coupled to the transformer unit unit 2011 and the synchronous rectification and filtering circuit 2013 to control an operation state of each of the transformer unit 2011 and the synchronous rectification and filtering circuit 2013.

In the present embodiment, as shown in FIG. 3, the first controller unit 2014 specifically includes a controller U101, wherein a first control pin 24 of the controller U101 is coupled to the primary coil of the transformer T101a, a second control pin 11 of the controller U101 is coupled to the first secondary coil of the transformer T101a through the resistor R212, a third control pin 9 of the controller U101 is coupled to the gate of the third switching transistor Q203, and a fourth control pin 4 of the controller U101 is coupled to the source of the third switching transistor Q203 through the capacitor C205.

In the present embodiment, in an application process, the first power is provided to the power input terminal 101, is rectified and filtered by the input filtering unit 203, the rectifying unit 204, and the 7C filtering unit 205.

When the first control pin 24 of the controller U101 controls the primary coil of the transformer T101a to be turned on, the second control pin 11, the third control pin 9, and the fourth control pin 4 of the controller U101 simultaneously control the third switching transistor Q203 to be turned off. At this time, a primary current and a magnetic flux in the transformer T101a are increased, so that energy is stored in the transformer T101a. An induction voltage in the first secondary coil of the transformer T101a is negative, and no energy is released from the first secondary coil of the transformer T101a.

When the first control pin 24 of the controller U101 controls the primary coil of the transformer T101a to be turned off, the second control pin 11, the third control pin 9, and the fourth control pin 4 of the controller U101 simultaneously control the third switching transistor Q203 to be turned on. At this time, the primary current and the magnetic flux in the transformer T101a are reduced. The induction voltage in the first secondary coil of the transformer T101a is positive, thereby allowing the transformer T101a to release the stored energy at the first secondary coil. That is, at this time, the transformer T101a outputs the first power after the voltage conversion at the first secondary coil, at the same time the third switching transistor Q203 performs rectifying and filtering on the first power, and the rectified and filtered first power is transmitted to the power output terminals 102.

In one embodiment of the present disclosure, the flyback conversion circuit 201 further includes the power conversion circuit 2015.

The power conversion circuit 2015 is coupled between the transformer unit 2011 and the first controller unit 2014, and is configured to convert the first power after the voltage conversion into third power for supply to the first controller unit 2014.

In the present embodiment, as shown in FIG. 3, the power conversion circuit 2015 specifically includes a second diode D106, a fourth switching transistor Q102, and a fifth resistor R106. The fourth switching transistor Q102 may adopt an N-channel Metal-Oxide-Semiconductor Field Effect Transistor (i.e., an NMOS transistor) or a P-channel Metal-Oxide-Semiconductor transistor (i.e., a PMOS transistor), which are not specifically limited in the present embodiment.

An anode of the second diode D106 is coupled to a first terminal 4 of a second secondary coil of the transformer T101a, a second terminal 3 of the second secondary coil of the transformer T101a is grounded, a cathode of the second diode D106 is coupled to a drain of the fourth switching transistor Q102, a gate of the fourth switching transistor Q102 is coupled to a fifth control pin 14 of the controller U101, a source of the fourth switching transistor Q102 is also coupled to the fifth control pin 14 of the controller U101 through the fifth resistor R106, a fourth capacitor C104 is coupled between the fifth control pin 14 and a sixth pin 13 of the controller U101, and a coupling point of the fourth capacitor C104 and the sixth pin 13 is grounded.

In the present embodiment, when the power supply circuit is in an initial power-up state, a power supply inside the controller U101 charges the fourth capacitor C104 through the fifth control pin 14 to supply power to a primary side of the controller U101. After the power supply circuit is normally started, when the first power is transmitted to the flyback conversion circuit 201 and the first control pin 24 of the controller U101 controls the primary coil of the transformer T101a to be turned on, the first power output from the second secondary coil of the transformer T101a is rectified by the second diode D106 and then transmitted to the fourth switching transistor Q102. When the rectified first power meets a conduction condition of the fourth switching transistor Q102, the fourth switching transistor Q102 is turned on, otherwise, the fourth switching transistor Q102 is not turned on. When the fourth switching transistor Q102 is turned on, the third power obtained by the conversion performed by the power conversion circuit 2015 is supplied to the primary side of the controller U101 through the fifth resistor R106, and meanwhile charges the fourth capacitor C104.

In the present embodiment, a voltage stabilizing diode is coupled to the fourth switching transistor Q102, an anode of the voltage stabilizing diode is coupled to a source of the fourth switching transistor Q102, and a cathode of the voltage stabilizing diode is coupled to a drain of the fourth switching transistor Q102. In the present embodiment, the rectified first power is regulated by the voltage stabilizing diode in the fourth switching transistor Q102 to obtain a stable third power. In the present embodiment, a circuit structure composed of a transistor and a voltage regulator that are connected in parallel may replace the fourth switching transistor Q102 provided with the voltage stabilizing diode in the present disclosure. A circuit structure having the same function as the fourth switching transistor Q102 in the present disclosure is within the protection scope of the present disclosure, which is not specifically limited in the present embodiment.

In the present embodiment, the power conversion circuit 2015 further includes a sixth resistor R107 and a fifth capacitor C129. The sixth resistor R107 and the fifth capacitor C129 are connected in series with each other, that is, one terminal of the sixth resistor R107 is coupled to one terminal of the fifth capacitor C129. The other terminal of the sixth resistor R107 is coupled to the anode of the second diode D106, and the other terminal of the fifth capacitor C129 is coupled to the cathode of the second diode D106. In the present embodiment, the sixth resistor R107 and the fifth capacitor C129 together constitute an RC absorption circuit for absorbing a peak voltage generated during a turning-off process of the fourth switching transistor Q102.

In the present embodiment, the power conversion circuit 2015 further includes a fourth electrolytic capacitor C109, an anode of which is coupled to the anode of the second diode D106, and a cathode of which is grounded.

In the application process, when the first power is transmitted to the flyback conversion circuit 201 and the first control pin 24 of the controller U101 controls the primary coil of the transformer T101a to be turned on, the first power output from the second secondary coil of the transformer T101a is rectified by the second diode D106 and then charges and stores energy in the fourth electrolytic capacitor C109. When the first control pin 24 of the controller U101 controls the primary coil of the transformer T101a to be turned off, the first power is discharged through the fourth electrolytic capacitor C109 to continue to be supplied to the fourth switching transistor Q102.

In one embodiment of the present disclosure, the flyback conversion circuit 201 further includes a sampling circuit 2017.

The sampling circuit 2017 is coupled to the first controller unit 2014 and a respective one of the power output terminals 102 to generate a sampled current when the respective one of the power output terminals 102 is connected to the external load.

In the present embodiment, as shown in FIG. 3, the sampling circuit 2017 specifically includes a sampling resistor R204, one terminal of which is coupled to the source of the third switching transistor Q203, the other terminal of which is coupled to the power output terminal 102. A seventh pin 1 and an eighth pin 2 of the controller U101 are coupled to two terminals of the sampling resistor R204, respectively.

In the application process, when the power output terminal 102 coupled to the sampling resistor R204 is externally connected to the external load, a current passes through a loop connected to the power output terminal 102 of the power supply circuit. That is, a sampled current is generated on the sampling resistor R204. Therefore, in the present embodiment, the seventh pin 1 and the eighth pin 2 of the controller U101 together detect whether there is the sampled current on the sampling resistor R204 to determine whether the power output terminal 102 coupled to the sampling resistor R204 is connected to the external load.

In the present embodiment, the sampling circuit 2017 further includes a seventh resistor R215 and a sixth capacitor C225. One terminal of the seventh resistor R215 is coupled to a coupling point between the sampling resistor R204 and the power output terminal 102, and the other terminal of the seventh resistor R215 is coupled to the seventh pin 1 of the controller U101. The sixth capacitor C225 is couple between the seventh pin 1 and the eighth pin 2. In the present embodiment, the seventh resistor R215 is used as a voltage dividing resistor of the sixth resistor R204 and used for voltage division, and the sixth capacitor C225 is used to filter out an alternating current in the sampled current.

In the present embodiment, the controller U101 further includes a ninth pin 5 and a tenth pin 6. The ninth pin 5 and the tenth pin 6 of the controller U101 communicate with a second controller unit 2022 (see below) to inform the second controller unit 2022 whether the power output terminal 102 is externally connected to the external load. In the present embodiment, when the controller U101 detects that there is the sampled current on the sampling resistor R204, the ninth pin 5 and the tenth pin 6 of the controller U101 communicate with the second controller unit 2022 so that the second controller unit 2022 determines that the power output terminal 102 coupled to the sampling resistor R204 has been connected to the external load.

In the present embodiment, the sampling circuit 2017 may also adopt other circuit structures which may be configured to generate the sampled current, which are not specifically limited in the present disclosure.

In the present disclosure, since the power supply circuit includes N flyback conversion circuits 201, wherein N≥2. That is, the power supply circuit may include two flyback conversion circuits 201, or may include more than two flyback conversion circuits 201. Each flyback conversion circuit 201 may have a same circuit structure or may have different circuit structures.

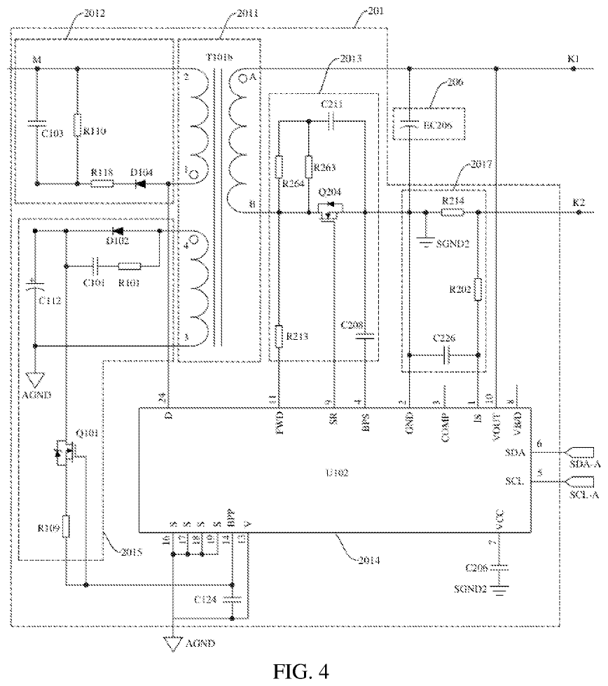

Illustratively, when N=2 (that is, the power supply circuit includes two flyback conversion circuits 201), the two flyback conversion circuits 201 may adopt the circuit structure of the flyback conversion circuit 201 described above. The two flyback conversion circuits 201 are coupled to an output terminal of the 7C filtering unit 205. A node M shown in FIGS. 2 to 5 is a coupling point between the two flyback conversion circuits 201 and the 7C filtering unit 205. That is, a structure of one of the two flyback conversion circuits 201 may be as shown in FIG. 3 and a structure of the other of the two flyback conversion circuits 201 may be as shown in FIG. 4. Since the flyback conversion circuit 201 shown in FIG. 4 has the same structure and function as the flyback conversion circuit 201 shown in FIG. 3, the structure of the other flyback conversion circuit 201 will not be repeated (however, in order to distinguish the two flyback conversion circuits 201, the reference numerals of components in the two flyback conversion circuits 201 shown in FIG. 3 are different from those in FIG. 4, and the specific structures of the two flyback conversion circuits 201 are as follows).

When N>2 (that is, the power supply circuit includes two or more flyback conversion circuits 201), each of the two or more flyback conversion circuits 201 may adopt the flyback conversion circuit 201 shown in FIG. 3 or shown in FIG. 4, or may adopt other circuit structures, or two or more of the N flyback conversion circuits 201 may adopt the flyback conversion circuit 201 shown in FIG. 3 or shown in FIG. 4 and the other of the flyback conversion circuits 201 may adopt other circuit structures.

Therefore, whether two or more flyback conversion circuits 201 are used, or whether each of the flyback conversion circuits 201 is of the same circuit structure or different circuit structures, any circuit structure capable of performing the same function as that of the at least two flyback conversion circuits 201 in the present disclosure is within the protection scope of the present disclosure. The circuit structure adopted by the two or more flyback conversion circuits 201 is not specifically limited herein.

In one embodiment of the present disclosure, the power supply circuit further includes an output filtering unit 206 coupled between the flyback conversion circuit 201 and the power output terminals 102 and configured to filter the first power after the flyback conversion.

In the present embodiment, the output filtering unit 206 may be a specific output filtering circuit.

In the present embodiment, as shown in FIG. 3, the output filtering unit 206 includes a fifth electrolytic capacitor EC205 coupled to a direct current bus between the first secondary coil of the transformer T101a and the power output terminal 102.

The fifth electrolytic capacitor EC205 filter the first power output by the flyback conversion circuit 201 to obtain the second power to be transmitted to the power output terminal 102. Meanwhile, the fifth electrolytic capacitor EC205 stores energy. When the flyback conversion circuit 201 supplies the first power to the power output terminal 102, the fifth electrolytic capacitor EC205 converts the first power to the second power, and meanwhile is charged to store the first power. When the first secondary coil of the transformer T101a is in a state of no energy release, the fifth electrolytic capacitor EC205 is discharged to the power output terminal 102 to continue to supply the second power to the power output terminal 102.

In the present embodiment, the output filtering unit 206 may also adopt other circuit structures which may have filtering and energy storage functions, which are not specifically limited in the present disclosure.

In one embodiment of the present disclosure, the flyback control circuit 202 includes a switch circuit 2021.

The switch circuit 2021 is coupled between two of the flyback conversion circuits 201 to control connection or disconnection of the two of the flyback conversion circuits 201.

The second controller unit 2022 is coupled to the switch circuit 2021 and configured to communicate with the first controller unit 2014 to receive a communication signal transmitted by the first controller unit 2021 upon detecting the sampled current, and control the switch circuit 2021 to be turned on or off based on the communication signal.

In the present embodiment, the switch circuit 2021 includes a two back-to-back switching transistors.

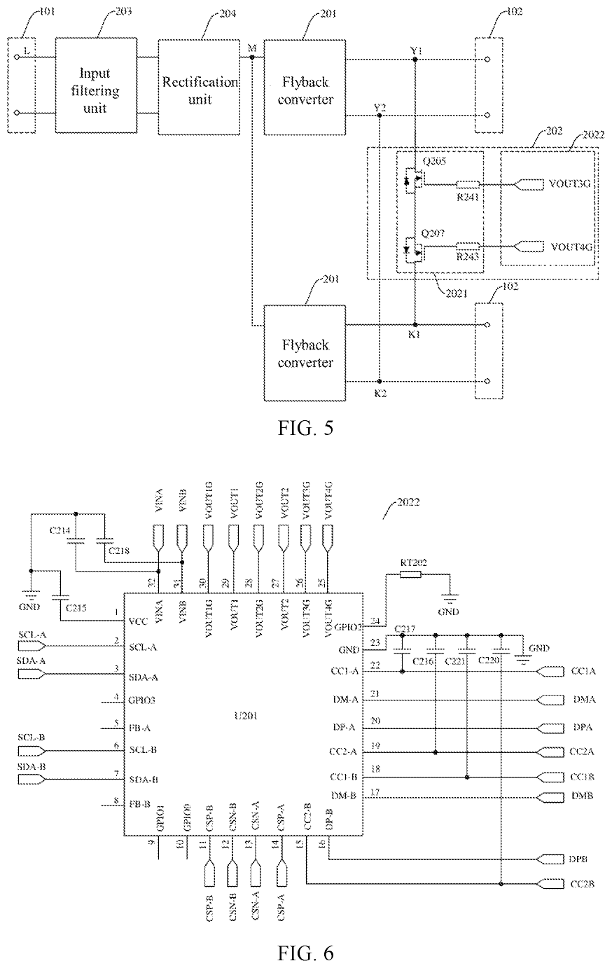

As shown in FIG. 5, the two back-to-back switching transistors may specifically include a first switching transistor Q205 and a second switching transistor Q207. The first switching transistor Q205 is connected to the second switching transistor Q207 in reverse series.

In the present embodiment, a first body diode is coupled to the first switching transistor Q205, an anode of the first body diode is coupled to a source of the first switching transistor Q205, and a cathode of the first body diode is coupled to a drain of the first switching transistor Q205. A second body diode is coupled in the second switching transistor Q207, an anode of the second body diode is coupled to a source of the second switching transistor Q207, and a cathode of the second body diode is coupled to a drain of the second switching transistor Q207.

Each of the first switching transistor Q205 and the second switching transistor Q207 may be an N-channel Metal-Oxide-Semiconductor Field Effect Transistor (i.e., an NMOS transistor) or a P-channel Metal-Oxide-Semiconductor transistor (i.e., a PMOS transistor). The first switching transistor Q205 and the second switching transistor Q207 may be a combination of two transistors of any type, which is not specifically limited in the present embodiment.

Specifically, as shown in FIG. 5, the source of the first switching transistor Q205 is coupled to the source of the second switching transistor Q207, the drain of the first switching transistor Q205 is coupled to a direct current bus between one of the flyback conversion circuits 201 and the power output terminal 102 corresponding to the one flyback conversion circuit 201, and a node Y1 and a node Y2 shown in FIGS. 2 to 5 and FIGS. 7 to 8 are coupling points of the first switching transistor Q205 and the direct current bus. The source of the second switching transistor Q207 is coupled to a direct current bus between the other of the flyback conversion circuits 201 and the power output terminal 102 corresponding to the other flyback conversion circuit 201, and a node K1 and a node K2 shown in FIGS. 2 to 5 and FIGS. 7 to 8 are coupling points of the first switching transistor Q205 and the direct current bus. A gate of the first switching transistor Q205 is coupled to the second controller unit 2022 through an eighth resistor R241. A gate of the second switching transistor Q207 is coupled to the second controller unit 2022 through a ninth resistor R243.

In the application process, when one of the two power output terminals 102 is connected to the external load, the first controller unit 2014 (the controller U101 or the controller U102) communicates with the second controller unit 2022 through the ninth pin 5 and the tenth pin 6 of the controller U101 according to the sampled current of the sampling resistor (either the sampling resistor R204 or the sampling resistor R214) connected to the corresponding first controller unit 2014. After the second controller unit 2022 determines that the external load is connected to one of the two power output terminals 102, the second controller unit 2022 controls the first switching transistor Q205 and the second switching transistor Q207 to be turned on, so that the two flyback conversion circuits 201 are connected in parallel. Subsequently, the second controller unit 2022 writes set power distribution values into corresponding registers through corresponding pins of the first controller unit 2014 of the two flyback conversion circuits 201, and controls other components in the two flyback conversion circuits 201 to operate through the two first controller units 2014. In this way, the at least two flyback conversion circuit 201 share current and withstand balanced output power, which solves a problem that when the power supply circuit supplies power through one power output terminal, the flyback conversion circuits 201 have to withstand an excessive current.

In the present embodiment, the first switching transistor Q205 and the second switching transistor Q207 are connected in series between the two flyback conversion circuits 201, and the anode of the first body diode is coupled to the source of the first switching transistor Q205, the cathode of the first body diode is coupled to the drain of the first switching transistor Q205, the anode of the second body diode is coupled to the source of the second switching transistor Q207, and the cathode of the second body diode is coupled to the drain of the second switching transistor Q207. This configuration can prevent one of the two flyback conversion circuits 201 that outputs a high voltage from output a voltage to the other of the two flyback conversion circuits 201 that outputs a low voltage, that is, preventing an output voltage from flowing back to the power supply circuit, which improve safety of the power supply circuit as a whole.

In the present embodiment, as shown in FIGS. 5 and 6, the second controller unit 2022 specifically includes a controller U201.

The controller U201 includes a pin SCL_A and a pin SDA_A, which are coupled to the ninth pin 5 and the tenth pin 6 of the controller U101, respectively. The pins SCL_A and SDA_A of the controller U201 are used to realize communication between the controller U201 and the controller U101.

The controller U201 further includes a pin SCL_B and a pin SDA_B, which are coupled to a first controller unit 2014 in another flyback control circuit 202, respectively. The pin SCL_B and the pin SDA_B of the controller U201 are used to realize communication between the controller U201 and another first controller unit 2014 (details can be seen in the figures).

The controller U201 further includes a pin VOUT3G and a pin VOUT4G, which are coupled to the eighth resistor R241 and the ninth resistor R243, respectively. The pins VOUT3G and VOUT4G of the controller U201 are used to control the first switching transistor Q205 and the second switching transistor Q207 to be turned on or off, respectively.

In the present embodiment, the controller U201 may adopt a PD protocol chip, or may adopt other chips having a same control function, which is not specifically limited in the present embodiment.

In the present disclosure, when N=2 (that is, the power supply circuit includes two flyback conversion circuits 201), the power supply circuit correspondingly includes one flyback control circuit 202, which may adopt a circuit structure as shown in FIG. 5, or may adopt other circuit structures.

When N>2 (that is, the power supply circuit includes more than two flyback conversion circuits 201), as an example, if the power supply circuit includes three flyback conversion circuits 201, the power supply circuit correspondingly includes three flyback control circuits 202. Every two of the three flyback control circuits 202 are coupled with one flyback control circuit 202. Each of the three flyback control circuits 202 may adopt a circuit structure as shown in FIG. 5, or may adopt other circuit structures, or one part of the three flyback control circuits 202 may adopt a circuit structure as shown in FIG. 5 and the other part of the three flyback control circuits 202 may adopt other circuit structures (not shown in the figures).

Therefore, any circuit structure capable of achieving the same function as the flyback control circuit 202 in the present disclosure is within the protection scope of the present disclosure, regardless of whether one flyback control circuits 202 is used or more than one flyback control circuits 202 are used and whether each of the flyback control circuits 202 is of the same circuit structure or a different circuit structure. The circuit structure used by the one or more flyback control circuits 202 is not specifically limited herein. In one embodiment of the present disclosure, the power supply circuit further includes: at least two output switch units 207.

Each of the at least two output switch units 207 is coupled between the flyback conversion circuit 201 and the power output terminal 102 corresponding to the flyback conversion circuit 201 to control connection or disconnection of the flyback conversion circuit 201 and the power output terminal 102.

In the present embodiment, the output switch unit 207 may be a specific output switch circuit.

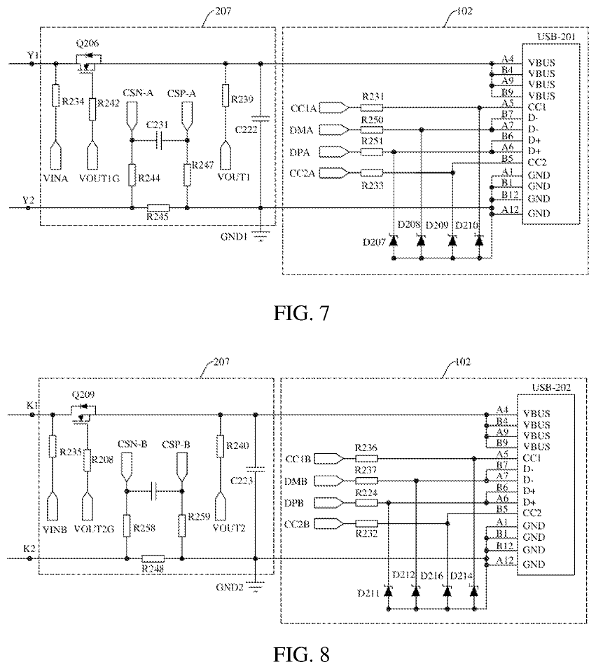

In the present embodiment, as shown in FIG. 7, the output switch unit 207 includes a fifth switching transistor Q206, a tenth resistor R234, an eleventh resistor R242, and a twelfth resistor R239.

The fifth switching transistor Q206 may use an N-channel Metal-Oxide-Semiconductor Field Effect Transistor (i.e., an NMOS transistor) or a P-channel Metal-Oxide-Semiconductor transistor (i.e., a PMOS transistor), which is not specifically limited in the present embodiment.

In the present embodiment, a fourth body diode is coupled to the fifth switching transistor Q206, an anode of which is coupled to a source of the fifth switching transistor Q206, and a cathode of which is coupled to a drain of the fifth switching transistor Q206.

In the present embodiment, the controller U201 further includes a pin VINA, a pin VOUT1G, and a pin VOUT1. A gate of the fifth switching transistor Q206 is coupled to the pin VOUT1G of the controller U201 through the eleventh resistor R242, the drain of the fifth switching transistor Q206 is coupled to a coupling point between the fifth electrolytic capacitor EC205 and the first secondary coil of the transformer T101a, the drain of the fifth switching transistor Q206 is further coupled to the pin VINA of the controller U201 through the tenth resistor R234, and the source of the fifth switching transistor Q206 is coupled to the power output terminal 102 and to the pin VOUT1 of the controller U201 through the twelfth resistor R239.

Since different external loads have different power limits, in the application process, after the power output terminal 102 is connected to the external load and performs protocol communicates with the external load, the controller U201 controls the fifth switching transistor Q206 to be turned on or off through the pin VINA, the pin VOUT1G, and the pin VOUT1 according to a power limit of the external load. When the power output to the power output terminal 102 meets a power limit requirement of the external load, the fifth switching transistor Q206 is turned on, otherwise, the fifth switching transistor Q206 is turned off, thereby avoiding a risk that a voltage or a current output from the power output terminal 102 to the external load exceeds a preset value within a predetermined time, thereby causing damage to the external load.

In the present embodiment, the output switch unit 207 further includes a seventh capacitor C231, a thirteenth resistor R245, a fourteenth resistor R244, and a fifteenth resistor R247. The thirteenth resistor R245 is coupled to an output bus connected to the power output terminal 102. Two terminals of the seventh capacitor C231 are coupled to one terminal of the fourteenth resistor R244 and one terminal of the fifteenth resistor R247, respectively, the other terminal of the fourteenth resistor R244 is coupled to one terminal of the thirteenth resistor R245, and the other terminal of the fifteenth resistor R247 is coupled to the other terminal of the thirteenth resistor R245.

In the present embodiment, the controller U201 further includes a pin CSN-A and a pin CSP-A, and the two terminals of the seventh capacitor C231 are further coupled to the CSN-A and the pin CSP-A of the controller U201, respectively.

In the present embodiment, the seventh capacitor C231 absorbs a peak voltage generated in the output bus of the power output terminal 102, and the thirteenth resistor R245, the fourteenth resistor R244, and the fifteenth resistor R247 function as dampers, so as to consume an overvoltage output to the power output terminal 102, thereby suppressing oscillation of a circuit. This further avoids the risk that the voltage or current output from the power output terminal 102 to the external load exceeds the preset value within the predetermined time, which causes damage to the external load.

In the present embodiment, the output switch unit 207 further includes an eighth capacitor C222 coupled to the output bus connected to the power output terminal 102. The second power output to the power output terminal 102 is filtered by the eighth capacitor C222.

In the present embodiment, the output switch unit 207 may also adopt other circuit structures that can prevent the overvoltage output of the power supply output 102, which are not specifically limited in the present disclosure.

In one embodiment of the present disclosure, the power output terminal 102 includes a female base USB-201. As shown in FIG. 7, in the application process, the power output terminal 102 is connected to the external load through the female base USB-201 to provide the second power to the external load.

In the present embodiment, the female base USB-201 is a female base of 14 pins, that is, the female base USB-201 includes a pin A4, a pin B4, a pin A9, a pin B9, a pin A5, a pin B7, a pin A7, a pin B6, a pin A6, a pin B5, a pin A1, a pin B1, a pin B12, and a pin A12. In the present embodiment, the pin A4, the pin B4, the pin A9, the pin B9, the pin A1, the pin B1, the pin B12, and the pin A12 of the female base USB-201 are commonly coupled to the output bus connected to the power output terminal 102;

In the present embodiment, the controller U201 further includes a pin CC1A, a pin DMA, a pin DPA and a pin CC2A. The pin A5, the pin A7, the pin A6, and the pin B5 of the female base USB-201 are coupled to the pin CC1A, the pin DMA, the pin DPA, and the pin CC2A of the controller U201 through the sixteenth resistor R231, the seventh resistor R250, the eighteenth resistor R251, and the nineteenth resistor R233, respectively;

In the present embodiment, when the female base USB-201 is externally connected to the external load, the protocol communication is realized with the external load through the pin CC1A, the pin DMA, the pin DPA, and the pin CC2A of the controller U201.

The pin A5, the pin A7, the pin A6, and the pin B5 of the female base USB-201 are coupled to an anode of a first voltage stabilizing transistor D210, the positive electrode of a second voltage regulator transistor D209, an anode of a third voltage stabilizing transistor D208, and an anode of the fourth voltage stabilizing transistor D207, respectively, and a cathode of the first voltage stabilizing transistor D210, a cathode of the second voltage stabilizing transistor D209, a cathode of the third voltage stabilizing transistor D208, and a cathode of the fourth voltage stabilizing transistor D207 are grounded.

In the present embodiment, the second power output to the female base USB-201 is stabilized by the first voltage stabilizing transistor D210, the second voltage stabilizing transistor D209, the third voltage stabilizing transistor D208, and the fourth voltage stabilizing transistor D207. At the same time, the second voltage stabilizing transistor D208 and the fourth voltage stabilizing transistor D207 can function to prevent back-filling, that is, preventing a voltage of the external load from being back-filled into the power supply circuit.

In the present disclosure, when N=2 (that is, the power supply circuit includes two flyback conversion circuits 201), the power supply circuit includes two output switch units 207 coupled to the two flyback conversion circuits 201, respectively, and two power output terminals 102 coupled to the two output switch units 207, respectively; One set of the output switch unit 207 and the power output terminal 102 in the power supply circuit may adopt the circuit structure shown in FIG. 7, and the other set of the power supply circuit may adopt a same circuit structure, that is, the other set of the power supply circuit may adopt the circuit structure shown in FIG. 8. Since the circuit structure shown in FIG. 7 is the same as the circuit structure shown in FIG. 8 and has a same function as that of the circuit structure shown in FIG. 8, the circuit structure shown in FIG. 8 will not be repeated again (in order to distinguish the output switch units 207 and the power output terminals 102 in the two sets, the reference numerals of components in the output switch units 207 and the power output terminals 102 in the two sets in FIG. 7 are different from those in FIG. 8, and specific structures of the output switch units 207 and the power output terminals 102 in the two sets are as shown in the accompanying drawings).

When N>2 (that is, the power supply circuit includes two or more flyback conversion circuits 201), illustratively, if the power supply circuit includes three flyback conversion circuits 201, correspondingly, the power supply circuit includes three output switch units 207 which are coupled to the three flyback conversion circuits 201 respectively and three power output terminals 102 which are coupled to the three output switch units 207 respectively.

Each set of the output switch unit 207 and the power output terminal 102 in the power supply circuit may adopt the circuit structure as shown in FIG. 7, or may adopt other circuit structures, or one part of the three sets of the output switch unit 207 and the power output terminal 102 adopts the circuit structure as shown in FIG. 7 and the other part thereof adopts other circuit structures (not shown in the drawings).

Therefore, any circuit structure capable of achieving the same function as the output switch unit(s) 207 and the power output terminal(s) 102, regardless of whether two output switch units 207 and two power output terminals 102 are used or more than two output switch units 207 and more than two power output terminals 102 are used, and regardless of what circuit structure(s) the output switch unit(s) 207 and the power output terminal(s) 102 adopt. The circuit structure(s) of the output switch unit(s) 207 and the power output terminal(s) 102 is not specifically limited herein.

In the present disclosure, when one of the two power output terminals 102 outputs the second power to the external load, output power of the two power output terminals includes but is not limited to the following: 5.0V/9.0V/12.0V/15.0V 3.0 A; 20.0V 2.25 A.

When both of the power output terminals 102 output the second power to the external load simultaneously, the output power of the two power outputs includes but is not limited to the following: a first power output terminal 102: 5.0V 3.0 A; 9.0V 2.22 A; 12.0V 1.67 A; and a second power output terminal 102: 5.0V 3.0 A; 9.0V 2.22 A; 12.0V 1.67 A.

The above data are merely examples based on the power supply circuit of the present disclosure. The power supply circuit of the present disclosure may also output the second power to the external load simultaneously through more than two power output terminals 102. The output power of the power output terminals 102 of the power supply circuit of the present disclosure may also be other values, which are not specifically limited in the present disclosure.

Therefore, the present disclosure can support simultaneous output of the second power through at least two power output terminals 102 under a single power supply without affecting each other. When one power output terminal 102 is for charging, a current can be shared, and a circuit structure in need of a DCDC plus protocol can be perfectly replaced.

In addition, the power supply circuit having the above-described structure has at least one of the following advantages.
(1) An electric energy conversion efficiency of the power supply circuit of the present disclosure equals an electric energy conversion efficiency of the power supply circuit formed by at least two AC/DC circuits, and is higher than an electric energy conversion efficiency of a power supply circuit formed by at least one AC/DC circuit plus at least two DC/DC circuits. Therefore, the present disclosure improves the electric energy conversion efficiency by using the power supply circuit of the above structure.
(2) Since the power supply circuit of the present disclosure may not include at least two DC/DC circuits, the structure of the power supply circuit of the present disclosure is smaller than that of the power supply circuit using at least one AC/DC circuit plus at least two DC/DC circuits, thereby facilitating reducing a volume of a device for loading the power supply circuit of the present disclosure.
(3) Since the power supply circuit of the present disclosure may not include at least two DC/DC circuits, compared to the power supply circuit using at least one AC/DC circuit plus at least two DC/DC circuits, the present disclosure can reduce a manufacturing cost of the power supply circuit.
(4) The power supply circuit of the present disclosure includes a circuit structure in which the at least two flyback conversion circuits 201 and the at least two power output terminals 102 are used, so that inputted power supply heat that is concentratedly generated can be dispersed into at least two rear circuits, so that heat in the power supply circuit can be evenly distributed, temperature of an outer surface of the device for loading the power supply circuit of the present disclosure is uniform, and a heat dissipation cost of the device is optimized.
(5) Since only when an operating frequency of the DC/DC circuit is controlled to be in a range of 300 kilohertz (kHz)˜500 kilohertz (kHz), can a small volume of the DC/DC circuit be realized, but when the operating frequency of the DC/DC circuit is 300 kHz˜500 kHz, radiation generated by the DC/DC circuit is quite large. Thus, a high manufacturing cost is additionally required to solve the radiation problem. Since the power supply circuit of the present disclosure may not include at least two DC/DC circuits, and the power supply circuit of the present disclosure is equivalent to the at least two AC/DC circuits, radiation generated by the at least two AC/DC circuits is much less than radiation of the at least two DC/DC circuits, and thus the present disclosure can reduce a cost of solving the radiation problem.
(6) The power supply circuit of the present disclosure supports more output power ranges, and can solve a problem of poor use experience due to limited output power.

Another embodiment of the present disclosure provides an electronic device including a power supply circuit according to any of the above-described embodiments. For a detailed explanation, refer to the foregoing embodiments, and details are not repeated herein. In the present embodiment, the electronic device may be a power adapter, a charging device, an expansion dock, or other device capable of realizing power transmission or data transmission, which are not specifically limited in the present embodiment.

The principles and implementations of the present disclosure are described above by some embodiments. The description of the embodiments is merely provided to help understand the present disclosure. Variations will occur to those skilled in the art based on the teachings of the present disclosure. Thus, the presented description should not be construed as limiting the present disclosure.

What is claimed is:

1. A power supply circuit, comprising:
a power input terminal configured to provide first power;
at least two power output terminals each configured to provide second power to an external load;
at least two flyback conversion circuits each coupled to the power input terminal and a respective one of the at least two power output terminals to convert the first power to the second power; and
a flyback control circuit coupled to each of the at least two flyback conversion circuits, the flyback control circuit being configured to control the at least two flyback conversion circuits to be connected in parallel when one of the at least two power output terminals outputs the second power.

2. The power supply circuit of claim 1, wherein each of the flyback conversion circuits comprises:
a transformer unit coupled between the power input terminal and a respective one of the power output terminals to perform voltage conversion on the first power.

3. The power supply circuit of claim 2, wherein each of the flyback conversion circuits further comprises:
a synchronous rectification and filtering circuit coupled between the transformer unit and a respective one of the power output terminals to rectify and filter the first power after the voltage conversion.

4. The power supply circuit of claim 3, wherein each of the flyback conversion circuits further comprises:
a first controller unit coupled to the transformer unit and the synchronous rectification and filtering circuit to control an operation state of each of the transformer unit and the synchronous rectification and filtering circuit.

5. The power supply circuit of claim 4, wherein each of the flyback conversion circuits further comprises:
a power conversion circuit coupled between the transformer unit and the first controller unit to convert the first power after the voltage conversion into third power for supply to the first controller unit.

6. The power supply circuit of claim 4, wherein each of the flyback conversion circuits further comprises:
a sampling circuit coupled to the first controller unit and a respective one of the power output terminals to generate a sampled current when the respective one of the power output terminals is connected to the external load.

7. The power supply circuit of claim 6, wherein the flyback control circuit comprises:
a switch circuit coupled between two of the flyback conversion circuits to control connection or disconnection of the two of the flyback conversion circuits; and
a second controller unit coupled to the switch circuit and configured to communicate with the first controller unit to receive a communication signal transmitted by the first controller unit upon detecting the sampled current and control the switch circuit to be turned on or off based on the communication signal.

8. The power supply circuit of claim 7, wherein the switch circuit comprises a bidirectional switch comprising two back-to-back switching transistors.

9. The power supply circuit of claim 1, further comprising at least two output switch units each coupled between a flyback conversion circuit of the flyback conversion circuits and a power output terminal of the power output terminals corresponding to the flyback conversion circuit to control connection or disconnection of the flyback conversion circuit with the power output terminal.

10. An electronic device comprising a power supply circuit, wherein the power supply circuit comprises:
a power input terminal configured to provide first power;
at least two power output terminals each configured to provide second power to an external load;
at least two flyback conversion circuits each coupled to the power input terminal and a respective one of the at least two power output terminals to convert the first power to the second power; and
a flyback control circuit coupled to each of the at least two flyback conversion circuits, the flyback control circuit being configured to control the at least two flyback conversion circuits to be connected in parallel when one of the at least two power output terminals outputs the second power.

11. The electronic device of claim 10, wherein each of the flyback conversion circuits comprises:
a transformer unit coupled between the power input terminal and a respective one of the power output terminals to perform voltage conversion on the first power.

12. The electronic device of claim 11, wherein each of the flyback conversion circuits further comprises:
a synchronous rectification and filtering circuit coupled between the transformer unit and a respective one of the power output terminals to rectify and filter the first power after the voltage conversion.

13. The electronic device of claim 12, wherein each of the flyback conversion circuits further comprises:
a first controller unit coupled to the transformer unit and the synchronous rectification and filtering circuit to control an operation state of each of the transformer unit and the synchronous rectification and filtering circuit.

14. The electronic device of claim 13, wherein each of the flyback conversion circuits further comprises:
a power conversion circuit coupled between the transformer unit and the first controller unit to convert the first power after the voltage conversion into third power for supply to the first controller unit.

15. The electronic device of claim 13, wherein each of the flyback conversion circuits further comprises:
a sampling circuit coupled to the first controller unit and a respective one of the power output terminals to generate a sampled current when the respective one of the power output terminals is connected to the external load.

16. The electronic device of claim 15, wherein the flyback control circuit comprises:
a switch circuit coupled between two of the flyback conversion circuits to control connection or disconnection of the two of the flyback conversion circuits; and
a second controller unit coupled to the switch circuit and configured to communicate with the first controller unit to receive a communication signal transmitted by the first controller unit upon detecting the sampled current and control the switch circuit to be turned on or off based on the communication signal.

17. The electronic device of claim 16, wherein the switch circuit comprises a bidirectional switch comprising two back-to-back switching transistors.

18. The electronic device of claim 10, wherein the power supply circuit further comprises at least two output switch units each coupled between a flyback conversion circuit of the flyback conversion circuits and a power output terminal of the power output terminals corresponding to the flyback conversion circuit to control connection or disconnection of the flyback conversion circuit with the power output terminal.
